(19) United States
(12) Patent Application Publication
(10) Pub. No.: US 2002/0009620 A1
(43) Pub. Date: Jan. 24, 2002

(54) Magnetic recording medium, production process thereof, and magnetic recording and reproducing apparatus

(75) Inventors: Kenzo Hanawa, Chiba (JP); Toshinori Asaumi, Chiba (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: SHOWA DENKO KABUSHIKI KAISHA

(21) Appl. No.: 09/861,624

(22) Filed: May 22, 2001

Related U.S. Application Data
(60) Provisional application No. 60/218,800, filed on Jul. 18, 2000.

(30) Foreign Application Priority Data
May 23, 2000 (JP) P2000-151998

(51) Int. Cl. G11B 5/64

(52) U.S. Cl. 428/694 TS

(57) ABSTRACT

An object of the present invention is to provide a magnetic recording medium exhibiting excellent magnetic characteristics, such as coercive force. On a substrate, a Cr-containing non-magnetic undercoat film is formed, and a magnetic film of a B-containing Co alloy is formed on the undercoat film. In the vicinity of the interface between the non-magnetic undercoat film and the magnetic film, the amount of Cr is 40 at % or less in a region R1, in which the amount of B is 1 at % or more.

### CROSS REFERENCE TO RELATED APPLICATIONS

This application is an application filed under 35 U.S.C. §111(a) claiming benefit pursuant to 35 U.S.C. §119(e)(1) of the filing date of Provisional Application 60/218,800 filed Jul. 18, 2000 pursuant to 35 U.S.C. §111(b).

### FIELD OF THE INVENTION

The present invention relates to a magnetic recording medium which is employed in, among other devices, a magnetic disk apparatus; a process for producing the medium; and a magnetic recording and reproducing apparatus comprising the medium.

### BACKGROUND OF THE INVENTION

Because high recording density has been a requirement for magnetic recording media employed in magnetic disk apparatuses, etc., enhancement of coercive force has been demanded. In order to enhance coercive force, a CoCrTa alloy, particularly, a Pt-containing CoCrPtTa alloy, has been employed as a material for forming a magnetic film.

In recent years, there has been a need for magnetic recording media to achieve higher recording density. In accordance with this trend, a B-containing Co alloy has become of interest as a material for forming a magnetic film which enables improvement of coercive force.

When a B-containing Co alloy, particularly, a Pt-containing CoCrPtB alloy, is employed, very high coercive force can be attained. In addition, since B exhibits an effect of causing crystal grains to be very fine, the magnetic crystal grains are reduced in size, and thus medium noise can be lowered.

Japanese Patent Application Laid-Open (kokai) Nos. 4-221418 and 5-205239 disclose a magnetic recording medium including a magnetic layer formed from a CoCrPtB alloy, which is formed on a Cr undercoat layer.

However, in a conventional magnetic recording medium in which a B-containing Co alloy is employed, improvement of orientation is difficult to attain, and as a result, ensured enhancement in magnetic characteristics, such as coercive force, is difficult.

### SUMMARY OF THE INVENTION

In view of the foregoing, an object of the present invention is to provide a magnetic recording medium exhibiting excellent magnetic characteristics, such as coercive force; a process for producing the medium; and a magnetic recording and reproducing apparatus comprising the medium.

The present inventors discovered that Cr contained in the undercoat film and B contained in the magnetic film form a covalent bond in the vicinity of the interface between these films when a magnetic film formed from a B-containing Co alloy is formed on an undercoat film containing Cr. The resulting covalent compound causes disturbance of the magnetic film's orientation. The present invention has been accomplished on the basis of this finding.

In order to enhance coercive force; decrease the distribution of coercive force; increase signal to noise ratio (SNR); and decrease isolated read pulse half-width (PW50), easy-magnetization axes (C axes) of crystals in a magnetic film of hexagonal close-packed (HCP) structure are preferably oriented in an in-plane direction.

In order to improve the orientation of a magnetic film, the film is preferably formed on an undercoat film consisting of Cr or a Cr alloy.

In general, when an undercoat film formed from Cr or a Cr alloy is provided on a magnetic recording medium substrate coated with a NiP film, the undercoat film is usually grown so that the (200) crystal plane becomes the surface. The lattice spacing of the (200) crystal plane of the undercoat film is similar to that of the (110) crystal plane of a Co alloy having an HCP structure, and thus a magnetic film formed from the Co alloy is epitaxially grown on the undercoat film so that the (110) crystal plane overlies the (200) crystal plane.

The present inventors have performed extensive studies, and discovered that Cr contained in the undercoat film and B contained in the magnetic film form a covalent bond in the vicinity of the interface between these films when a Co alloy constituting the magnetic film contains B. The resulting covalent compound impedes epitaxial growth of the magnetic film, and since the magnetic film is not grown so that the (110) crystal plane overlies the (200) crystal plane, the magnetic film orientation is disturbed, and consequently magnetic characteristics such as coercive force, may deteriorate.

Therefore, when the amount of either Cr or B is lowered in the vicinity of the interface between the undercoat film and the magnetic film to prevent formation of a covalent compound from Cr and B, disturbance in magnetic film orientation can be prevented.

The present invention provides a magnetic recording medium comprising a substrate; a non-magnetic undercoat film containing Cr, which is provided on the substrate; and a magnetic film formed from a B-containing Co alloy, which is provided on the undercoat film. In the vicinity of the interface between the non-magnetic undercoat film and the magnetic film, the amount of Cr is 40 at % or less in the region at which the amount of B is 1 at % or more.

In the present invention, when the amounts of Cr and B are within the above ranges, coexistence of large amounts of Cr and B in the vicinity of the interface is prevented, and formation of a covalent compound from Cr and B is largely suppressed. As a result, disturbance in magnetic film orientation, which is caused by the covalent compound, can be prevented.

Therefore, magnetic characteristics, such as coercive force, can be enhanced.

Preferably, the Co alloy constituting the magnetic film contains Pt, and the amounts of Pt and B are 1-20 at % and 1-10 at %, respectively.

Preferably, the magnetic film has a structure so that large amounts of magnetic crystal grains are separated from one another by intergrain regions, and the mean size of the magnetic crystal grains is preferably 6-20 nm.

Preferably, the non-magnetic undercoat film is formed from Cr or a Cr alloy, and the Cr alloy contains one or more of CrMo, CrW, CrV, and CrTi alloys.

Preferably, the mean surface roughness (Ra) of the non-magnetic substrate is 0.1-1 nm.

The present invention also provides a process for producing a magnetic recording medium, which comprises providing a non-magnetic undercoat film containing Cr on a substrate; and providing a magnetic film formed from a B-containing Co alloy on the undercoat film. The magnetic film is formed so that the amount of Cr is 40 at % or less in the region in which the amount of B is 1 at % or more in the vicinity of the interface between the non-magnetic undercoat film and the magnetic film.

The present invention also provides a magnetic recording and reproducing apparatus comprising a magnetic recording medium and a magnetic head for recording data into the medium and reproducing the data therefrom. The magnetic recording medium comprises a substrate, a non-magnetic undercoat film containing Cr, and a magnetic film formed from a B-containing Co alloy in order; and, in the vicinity of the interface between the non-magnetic undercoat film and the magnetic film, the amount of Cr is 40 at % or less in the region in which the amount of B is 1 at % or more.

### BRIEF DESCRIPTION OF THE DRAWINGS

FIG. 1 is a partial cross-sectional view of one embodiment of the magnetic recording medium of the present invention.

FIG. 2 shows profiles of the chemical compositions on an average basis of the non-magnetic undercoat film and the magnetic film of the magnetic recording medium shown in FIG. 1 in the vicinity of the interface between the films in a vertical direction with respect to the films.

FIG. 3(a) shows the microstructure of the magnetic recording medium shown in FIG. 1; and

FIG. 3(b) shows profiles of the chemical compositions in a vertical direction with respect to the film at a magnetic crystal grain.

FIG. 4 is a schematic representation showing an embodiment of a magnetic recording and reproducing apparatus including the magnetic recording medium shown in FIG. 1.

FIG. 5 shows profiles of the chemical compositions on an average basis of the non-magnetic undercoat film and the magnetic film of the magnetic recording medium in the vicinity of the interface between the films in a vertical direction with respect to the films. The magnetic film being formed on the non-magnetic undercoat film by applying the material of the magnetic film directly onto the undercoat film.

FIG. 6(a) shows the microstructure of the magnetic recording medium in which the magnetic film is formed on the non-magnetic undercoat film by applying the material of the magnetic film directly onto the undercoat film.

FIG. 6(b) shows profiles of the chemical compositions in a vertical direction with respect to the film at a magnetic crystal grain.

FIG. 7 shows profiles of the chemical compositions on an average basis of the non-magnetic undercoat film and the magnetic film of the magnetic recording medium of Example 4 in the vicinity of the interface between the films in a vertical direction with respect to the films.

FIG. 8 shows profiles of the chemical compositions on an average basis of the non-magnetic undercoat film and the magnetic film of the magnetic recording medium of Example 8 in the vicinity of the interface between the films in a vertical direction with respect to the films.

FIG. 9 shows profiles of the chemical compositions on an average basis of the non-magnetic undercoat film and the magnetic film of the magnetic recording medium of the Comparative Example 4 in the vicinity of the interface between the films in a vertical direction with respect to the films.

### DESCRIPTION OF THE PRESENT INVENTION

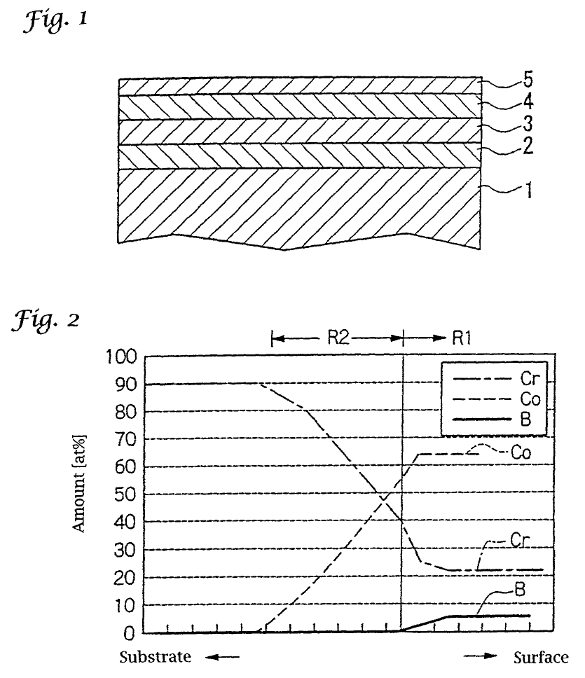

FIG. 1 is a schematic representation showing an embodiment of the magnetic recording medium of the present invention. The magnetic recording medium includes a non-magnetic substrate 1, a non-magnetic undercoat film 2, a magnetic film 3, a protective film 4, and a lubrication layer 5, the films and the layer being successively formed on the substrate.

The non-magnetic substrate 1 may be an aluminum substrate, a glass substrate, a ceramic substrate, a carbon substrate, or a flexible resin substrate; or any such substrates coated with a NiP film through plating or sputtering.

The substrate 1 may be coated with a NiAl film instead of a NiP film.

When the substrate 1 is coated with a NiAl film, the thickness of the film is preferably 10-100 nm, since orientation of the undercoat film 2 can be enhanced.

The non-magnetic substrate 1 is subjected to texturing in a circumferential direction to attain a mean surface roughness (Ra) of 0.1-1 nm (1-10 Å), preferably 0.2-0.8 nm (2-8 Å).

When the mean surface roughness (Ra) is below the above range, the non-magnetic substrate 1 becomes excessively smooth, and thus orientation of the undercoat film 2 or the magnetic film 3 in a circumferential direction is disturbed. In contrast, when the mean surface roughness (Ra) is in excess of the above range, crystal grains become large in the non-magnetic undercoat film 2, and this causes magnetic crystal grains to become large in the magnetic film 3, resulting in an increase in medium noise.

When the non-magnetic substrate 1 is not subjected to texturing, the mean surface roughness (Ra) is 0.5 nm or less (5 Å or less), preferably 0.2 nm or less (2 Å or less).

The non-magnetic undercoat film 2 is provided to enhance orientation of the magnetic film 3, and the film 2 is preferably formed from Cr or a Cr alloy.

The Cr alloy may contain one or more of CrMo, CrW, CrV, and CrTi alloys.

When the CrMo, CrW, CrV, or CrTi alloy is employed, the respective amount of Mo, W, V, or Ti falls within the range of 0.1-30 at %.

The non-magnetic undercoat film 2 may contain another element in addition to the above material, as long as the element does not impair the crystallinity of the undercoat film 2.

The non-magnetic undercoat film 2 may have either a single-layer structure or a multi-layer structure, in which a plurality of layers formed from a single material or different materials are laminated with one another. For example, the non-magnetic undercoat film 2 may be a multi-layer film in which layers of Cr and layers of the aforementioned Cr alloy are repeatedly laminated.

The thickness of the non-magnetic undercoat film 2 is preferably 1-100 nm (10-1,000 Å), more preferably 2-50 nm (20-500 Å). When the thickness is below the above range, orientation is disturbed, whereas when the thickness is in excess of the above range crystal grains become large, and magnetic crystal grains become large in the magnetic film 3.

The magnetic film 3 is formed from a B-containing Co alloy.

The Co alloy may be a CoCrB alloy, and is particularly preferably a Pt-containing CoCrPtB alloy.

The amount of B contained in the Co alloy is preferably 1-10 at %, more preferably 2-7 at %, and even more preferably 2.5-6 at %.

When the amount of B is below the above range, coercive force decreases, and magnetic crystal grains become large, resulting in an increase in noise. In contrast, when the amount of B is in excess of the above range, orientation in the magnetic film 3 is disturbed, and coercive force may be lowered.

The amount of Cr contained in the Co alloy is preferably 40 at % or less, more preferably 5-35 at %, and even more preferably 10-25 at %.

In the case in which a Pt-containing CoCrPtB alloy is employed, when the amount of Pt contained in the alloy is very small, the alloy cannot enhance coercive force to any significant extent. In contrast, when the amount of Pt is very large, magnetization of the magnetic film 3 decreases and coercive force increases. However, since the magnetic film must be thick enough to obtain sufficient reproduction signal output, magnetic crystal grains become large, and thus noise increases.

Therefore, the amount of Pt contained in the alloy is preferably 1-20 at %, more preferably 3-16 at %, and even more preferably 6-14 at %.

The Co alloy may contain one or more species of Ta, Zr, Cu, and Nb.

The magnetic film 3 may have either a single-layer structure or a multi-layer structure, in which a plurality of layers formed from a single material or different materials are laminated with one another.

The thickness of the magnetic film 3 is preferably 5-100 nm (50-1,000 Å). When the thickness is below the above range, coercive force is lowered, whereas when the thickness is in excess of the above range, magnetic crystal grains in the magnetic film 3 tend to become large, and thus noise characteristics may deteriorate.

The thickness of the magnetic film 3 is more preferably 10-50 nm (100-500 Å). When the thickness is below the above range, reproduction signal output decreases. In contrast, when the thickness is in excess of the above range, reproduction signal output decreases when recording and reproduction are carried out at high frequency regions where recording at high density is desirable.

FIG. 2 shows profiles of the chemical compositions of the non-magnetic undercoat film 2 and the magnetic film 3, which constitute the magnetic recording medium of the embodiment in the vicinity of the interface between the films in a vertical direction with respect to the films. As shown in FIG. 2, in the vicinity of the interface between the non-magnetic undercoat film 2 and the magnetic film 3, the amount of Cr gradually decreases at the interface side region, but the amount of B gradually increases.

As shown in FIG. 2, in the vicinity of the interface between these films of the magnetic recording medium of the embodiment, the amount of Cr is 40 at % or less in a region R1, in which the amount of B is 1 at % or more.

When the amount of Cr is in excess of 40 at % in the region R1, orientation of the magnetic film 3 is disturbed, and thus coercive force is lowered.

The profiles of the chemical compositions shown in FIG. 2 are on an average basis as determined in an in-plane direction of the substrate.

The distribution of the amounts of Cr and B in the vicinity of the interface between the non-magnetic undercoat film 2 and the magnetic film 3 will next be described in detail.

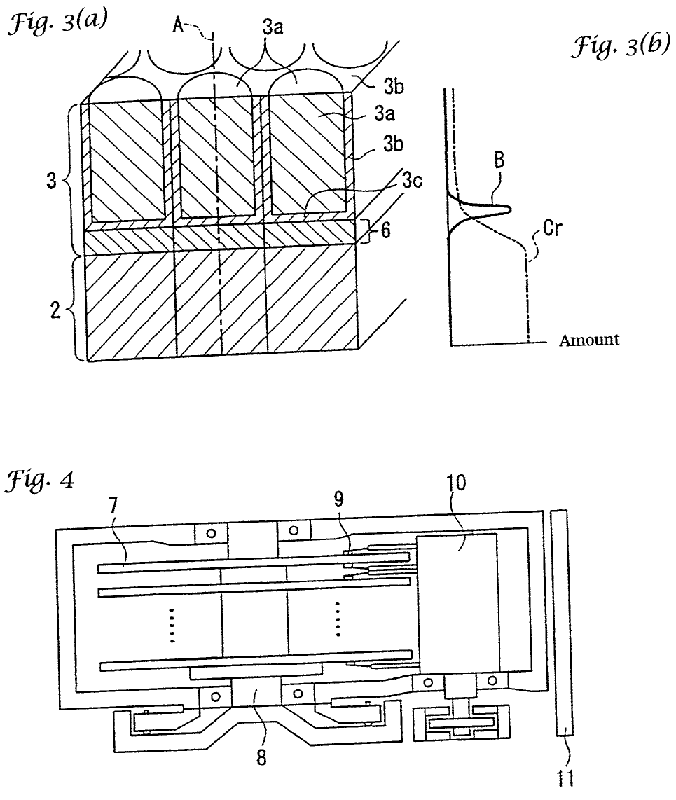

FIG. 3(a) shows the microstructure of the magnetic film 3. As shown in FIG. 3(a), the magnetic film 3 has a structure in which large amounts of magnetic crystal grains 3a consisting of a Co alloy (e.g., a CoCrPtB alloy) are separated from one another by intergrain regions 3b.

The mean size of the magnetic crystal grains 3a in an in-plane direction of the substrate is preferably 6-20 nm (60-200 Å). The mean size of the grains 3a is more preferably 7-15 nm, and even more preferably 8-10 nm.

When the grain size is below the above range, the effect of thermal decay is significant, whereas when the grain size is in excess of the above range, medium noise increases, which is unsatisfactory. The size of the magnetic crystal grains 3a can be measured from images obtained through use of, for example, a transmission electron microscope (TEM).

The intergrain regions 3b consist of the same constitutional component as that of the magnetic crystal grains 3a (e.g., a CoCrPtB alloy). However, the regions 3b differ in composition from the grains 3a, so that Cr and B are contained in greater amounts in the regions 3b than in the grains 3a.

Reference numeral 3c represents a segregation layer. Similar to the intergrain regions 3b, B is contained in the layer in greater amounts than in the magnetic crystal grains 3a.

FIG. 3(b) shows profiles of the chemical compositions of the non-magnetic undercoat film 2 and the magnetic film 3 in the vicinity of the interface therebetween in a vertical direction with respect to the films at a magnetic crystal grain 3a (i.e., at the position represented by reference numeral A).

In a region 6 in the vicinity of the non-magnetic undercoat film 2 and the magnetic film 3 (i.e., the lowermost portion of the film 3), the amount of Cr gradually decreases in a vertical direction with respect to the films toward the film 3.

The amounts of the elements vary continuously in the region 6. The reason is thought to be as follows: the material of the magnetic film 3, deposited to the surface of the undercoat film 2, diffuses in the surface and is mixed with the material of the film 2 at an early stage of growth of the film 3.

At the upper side portion of the region 6, the amount of Cr is satisfactorily low; i.e., 40 at % or less.

On the region 6 of the magnetic film 3, the segregation layer 3c is formed, in which B contained is a greater amount than in the magnetic crystal grains 3a, similar to the condition pertaining to the intergrain regions 3b. In the segregation layer 3c, the amount of Cr is satisfactorily low; i.e., 40 at % or less. Therefore, Cr and B encounter difficulty in forming a covalent compound.

When a substrate coated with a NiP film is employed as the non-magnetic substrate 1, the non-magnetic undercoat film 2 is usually grown so that the (200) crystal plane becomes the surface. The lattice spacing of the (200) crystal plane of the undercoat film 2 is similar to that of the (110) crystal plane of a Co alloy having an HCP structure, and thus the magnetic film 3 is epitaxially grown on the undercoat film 2 so that the (110) crystal plane overlies the (200) crystal plane.

When a substrate coated with a NiAl film is employed as the non-magnetic substrate 1, the non-magnetic undercoat film 2 is usually grown so that the (112) crystal plane becomes the surface. The lattice spacing of the (112) crystal plane of the undercoat film 2 is similar to that of the (100) crystal plane of a Co alloy having an HCP structure, and thus the magnetic film 3 is epitaxially grown on the undercoat film 2 so that the (100) crystal plane overlies the (112) crystal plane.

The protective film 4 is provided to prevent corrosion of the magnetic film 3 and to protect the surface of the magnetic recording medium from any damage. Conventionally known materials may be employed to form the film 4. Examples of the materials include a single composition of C, SiO₂, or ZrO₂, or a composition containing C, SiO₂, or ZrO₂ as a primary component and other elements.

From the viewpoints of corrosion resistance and tribology, the thickness of the protective film 4 is preferably 1-20 nm (i.e., 10-200 Å). In order to reduce spacing loss and obtain sufficient reproduction output, the thickness of the film 4 is more preferably 1-10 nm (i.e., 10-100 Å).

The lubrication film 5 is preferably formed from perfluoropolyether, fluorinated alcohol, or fluorinated carboxylic acid.

The process for producing the magnetic recording medium of the embodiment will next be described by taking a production process for the above-described magnetic recording medium, as an example.

When a substrate coated with a NiP film is employed as the non-magnetic substrate 1, the undercoat film 2 is preferably formed at 180-250° C., with an object of enhancing the orientation of the film 2.

On the non-magnetic substrate 1, the non-magnetic undercoat film 2 is formed through sputtering by use of Cr or a Cr alloy.

In the production process of the embodiment, the magnetic film 3 is formed on the non-magnetic undercoat film 2 so that the amount of Cr is 40 at % or less in the region R1 in the vicinity of the interface between the films 2 and 3, in which the amount of B is 1 at % or more.

The magnetic film 3 can be formed so that the amount of Cr is 40 at % or less in the region R1, in which the amount of B is 1 at % or more, through, for example, the following process.

In the process, a first target and a second target are provided. The first target consists of a material containing B and Cr in amounts of less than 1 at % and 40 at % or less, respectively. The second target consists of other material constituting the magnetic film 3.

Examples of the materials of the first and second targets are described below. When the magnetic film 3 is formed from Co-22 at % Cr-10 at % Pt-5 at % B (Co22Cr10Pt5B), a CoCr alloy; for example, Co-40 at % Cr (Co40Cr), may be employed as the material of the first target, and Co22Cr10Pt5B, which constitutes the magnetic film 3, may be employed as the material of the second target.

Firstly, the material of the first target containing Cr in an amount of 40 at % or less is deposited to the non-magnetic undercoat film 2 through sputtering.

When the material of the first target is deposited to the non-magnetic undercoat film 2, at a very early stage, the material is mixed with the material of the film 2 containing a large amount of Cr, and thus the amount of Cr contained in the resultant film becomes large. However, the amount of Cr contained in the film decreases with growth of the film, and finally the amount of Cr becomes 40 at % or less.

As shown in FIG. 2, the amount of Cr is 40 at % or less at the uppermost portion (the outermost portion) of the region R2 formed from the first target. The region R2 corresponds to the region 6 shown in FIG. 3(a), in which the amount of Cr decreases.

Subsequently, the material of the second target, which constitutes the magnetic film 3, is deposited thereto to form the film 3.

Some of the elements contained in the materials of the first and second targets deposited onto the non-magnetic undercoat film 2 are segregated, and, as shown in FIG. 3(a), the magnetic film 3 assumes a structure so that large amounts of the magnetic crystal grains 3a are separated from one another by the intergrain regions 3b.

The amount of B is 1 at % or more in the region formed from the second target consisting of the material of the magnetic film 3, and the amount of Cr is 40 at % or less at the uppermost portion in the region R2 formed from the first target. Therefore, in the vicinity of the interface between the non-magnetic undercoat film 2 and the magnetic film 3 of the resultant magnetic recording medium, the amount of Cr is 40 at % or less in the region R1, in which the amount of B is 1 at % or more.

FIG. 4 shows an embodiment of the magnetic recording and reproducing apparatus including the magnetic recording medium. The apparatus includes a magnetic recording medium 7, the structure of the medium being shown in FIG. 1; a medium-driving portion 8 which rotates the medium 7; a magnetic head 9 which is employed for recording of data onto the medium 7 and for reproduction of the data from the medium 7; a head-driving portion 10; and a recorded/reproduced signal-processing system 11. In the system 11, a recorded external signal is processed and sent to the magnetic head 9, or a reproduction signal from the head 9 is processed and sent to the outside.

In the vicinity of the interface between the non-magnetic undercoat film 2 and the magnetic film 3 of the magnetic recording medium of the embodiment, the amount of Cr is 40 at % or less in the region R1, in which the amount of B is 1 at % or more. Therefore, the disturbance of the orientation of the magnetic film 3 can be prevented, and magnetic characteristics, such as coercive force, can be enhanced.

It is thought that the disturbance of the orientation of the magnetic film 3 can be prevented for the following reasons.

When a Co alloy constituting the magnetic film contains B, Cr contained in the undercoat film and B contained in the magnetic film form a covalent bond in the vicinity of the interface between these films, and the resultant covalent compound impedes epitaxial growth of the magnetic film. Consequently, orientation of the magnetic film may be disturbed, and magnetic characteristics, such as coercive force, may deteriorate.

In the magnetic recording medium of the embodiment, coexistence of large amounts of Cr and B in the vicinity of the interface between the non-magnetic undercoat film 2 and the magnetic film 3 can be prevented by determining the amounts of Cr and B within the aforementioned ranges in the vicinity of the interface.

Therefore, formation of a covalent compound from Cr and B is suppressed to the utmost, thereby preventing disturbance of the orientation of the magnetic film 3, which is caused by the covalent compound.

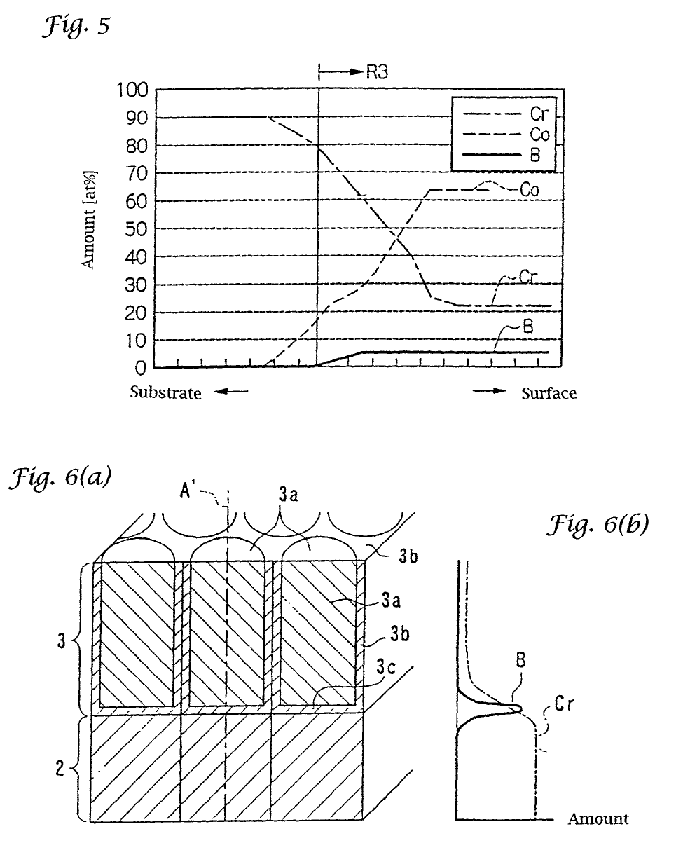

In contrast, as shown in FIG. 5 illustrating profiles of chemical compositions on an average basis, when the amount of Cr is in excess of 40 at % in the region R3, in which the amount of B is 1 at % or more in the vicinity of the interface between the non-magnetic undercoat film 2 and the magnetic film 3, Cr and B form a covalent compound in the region R3, in which the amounts of Cr and B are both large. Consequently, orientation of the magnetic film is disturbed by the resulting covalent compound, and thereby deteriorating magnetic characteristics, such as coercive force.

When the magnetic film 3 is formed directly on the non-magnetic undercoat film 2 by use of only the second target consisting of the material of the film 3 without use of the first target, the aforementioned chemical composition profiles are obtained. This is because, during formation of the magnetic film 3, the amount of B becomes more than 1 at % before the amount of Cr decreases to 40 at % or less.

FIG. 6(a) shows the microstructure of the magnetic film 3 where the film 3 is formed directly on the non-magnetic undercoat film 2; and FIG. 6(b) shows profiles of the chemical compositions of these films in a vertical direction with respect to the films at the magnetic crystal grain 3a (i.e., at the position represented by reference numeral A′).

As shown in FIG. 6(b), in the vicinity of the interface between the non-magnetic undercoat film 2 and the magnetic film 3 of the magnetic recording medium, the amount of Cr gradually decreases in a vertical direction with respect to the films toward the film 3. However, since the segregation layer 3c is formed at the lowermost portion of the film 3, which is brought into contact with the film 2, the amount of Cr is large in the layer 3c.

As described above, the amount of Cr is large in the segregation layer 3c, in which the amount of B is also large, and thus a covalent compound tends to be formed from Cr and B.

According to the process for producing the magnetic recording medium of the present invention, a magnetic recording medium, which prevents disturbance of orientation of the magnetic film 3 and in which coercive force can be enhanced, can be produced.

According to the magnetic recording and reproducing apparatus of the present invention, coercive force of the magnetic recording medium can be enhanced, and recording density can be increased.

The method of the above-described embodiment is drawn to a process in which the first target, which consists of a material containing B and Cr in amounts of less than 1 at % and 40 at % or less, respectively, is employed before the second target consisting of a material constituting the magnetic film 3. However, in the present invention, the first target is not limited to a material consisting of elements constituting the magnetic film 3. The first target may be any material as long as the material does not cause disturbance of orientation and deterioration of magnetic characteristics even when the material diffuses into the magnetic film formed from the second target.

For example, the material of the first target may be a NiCr alloy. The NiCr alloy has a crystal structure which differs from the HCP structure of a Co alloy, but even when Ni forms a solid solution in the Co alloy constituting the magnetic film 3, Ni does not cause deterioration of magnetic characteristics. Therefore, the NiCr alloy can be employed as the material of the first target.

In an embodiment, the process in which the first and second targets are employed is described. However, in the present invention, three or more targets may be employed.

For example, the following process may be carried out in the present invention. Firstly, the following targets are provided; a first target consisting of a CoCr alloy containing Cr in an amount of 40 at % or less; a second target consisting of a CoPt alloy; a third target consisting of a CoB alloy; and a fourth target consisting of Cr. At an early stage of film formation, the materials of the first and second targets, which contain B and Cr in amounts of less than 1 at % and 40 at % or less, respectively, are deposited onto the non-magnetic undercoat film 2. When the amount of Cr contained in the deposited material decreases to 40 at % or less, in addition to the first and second targets, the B-containing third target and the fourth target are employed to thereby form a film.

In the present invention, when a Ta-containing Co alloy is employed to form the magnetic film 3, in the vicinity of the interface between the non-magnetic undercoat film 2 and the magnetic film 3, the amount of Cr is preferably 40 at % or less in the region, in which the total amount of B and Ta is 1 at % or more.

This is because, when the amount of Cr is in excess of 40 at % in the region, in which the total amount of B and Ta is 1 at % or more, Ta and/or B form a covalent bond with Cr, since Ta (similar to B), can form a covalent bond with Cr. The resulting covalent compound may cause disturbance of orientation of the magnetic film.

### EXAMPLES

Effects of the present invention will be described by way of Examples, which are not intended to be construed as limiting the scope of the present invention. Unless indicated otherwise herein, all parts, percents, ratios and the like are by weight.

A magnetic recording medium as shown in FIG. 1 was produced according to the following procedure.

### Examples 1 through 8

An aluminum substrate 1 (diameter: 95 mm, thickness: 0.8 mm) on which a NiP film (thickness: 10 μm) had been formed through electroless plating was subjected to polishing and then to texturing to attain a mean surface roughness (Ra) of 0.5 nm.

Subsequently, on the non-magnetic substrate 1, a non-magnetic undercoat film 2 and a magnetic film 3 were formed through sputtering by use of a DC magnetron sputtering apparatus (model: 3010, product of ANELVA).

During formation of the magnetic film 3, a first target consisting of Co-40at % Cr (Co40Cr) or Ni-40 at % Cr (Ni40Cr), not containing B, was employed at an early stage of film formation, and then a second target consisting of Co-22 at % Cr-10 at % Pt-5 at % B (Co22Cr10Pt5B) was employed.

In Examples 1 through 3 and 5 through 7, the non-magnetic undercoat film 2 was a two-layer structure film containing a first undercoat layer formed from Cr and a second undercoat layer formed from a Cr alloy.

Prior to film formation, a chamber of the sputtering apparatus was evacuated to 9×10⁻⁶ Pa. During film formation, the inner pressure of the chamber was 6×10⁻¹ Pa.

On the magnetic film 3, a protective film 4 consisting of carbon (thickness: 80 Å) was formed through sputtering, and then a lubrication film 5 (Z-Dol, product of Fomblin) (thickness: 17 Å) was formed on the film 4 through dipping, after which the resultant medium was subjected to tape burnish processing.

The glide height of the thus-produced magnetic recording medium was measured by use of a BG tester, and the medium was confirmed to have attained a glide height of 0.7 μinch.

### Comparative Examples 1 through 4

The procedure of Examples 1-7 were repeated, except that the magnetic film 3 was formed by use of only the second target consisting of Co22Cr10Pt5B to produce a magnetic recording medium.

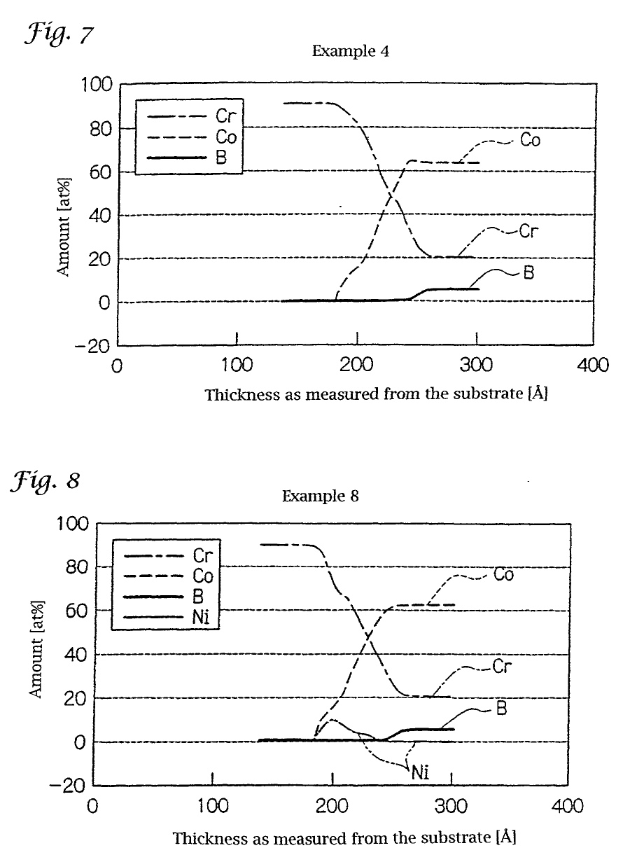

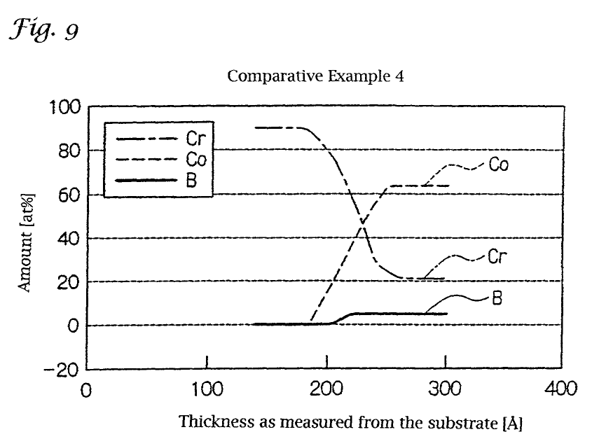

FIGS. 7, 8, and 9 show profiles of the chemical compositions on an average basis of magnetic recording media in a vertical direction with respect to the film of Examples 4 and 8, and Comparative Example 4, respectively. The chemical compositions of the respective media were measured by use of an Auger spectroscopic analysis apparatus (model: MicroLab-310F, product of VG Scientific) under the following conditions: acceleration voltage 10 kV, ion source Ar, and sample voltage 45 nA.

Electromagnetic conversion characteristics of the magnetic recording media were measured by use of read/write analyzer RWA1632 and spin stand S1701MP (products of GUZIK). In order to evaluate electromagnetic conversion characteristics, measurement was performed by use of a complex-type thin film magnetic recording head containing a giant magnetoresistive (GMR) element at the reproduction portion, and track-recording density was set at 280 kFCI. Tables 1 and 2 show the results of measurement of the magnetic recording media in the above-described Examples and Comparative Examples in terms of magnetostatic characteristics and electromagnetic conversion characteristics.

In Table 2, the symbol “Hc” refers to coercive force. The value “S*” is obtained through the following procedure. Firstly, a B-H hysteresis loop is prepared by use of a vibrating sample magnetometer (VSM); the value of H in the hysteresis loop at B=0 is assigned as “Hc” or “−Hc”; the point of intersection of the tangent to the loop at H=Hc and the line B=−Br is obtained; the value of H at the point is assigned as “H*”; and the values “Hc” and “H*” are employed in the following formula S*=(H*)/Hc to obtain S*.

When S* is low, even if saturated magnetization of the magnetic recording medium is high, residual magnetization, which is an important characteristic, is low. Therefore, electromagnetic conversion characteristics, which are necessary for recording and reproduction, cannot be obtained. S* can be regarded as an index of high Br. In general, a Co alloy film having an S* of 0.8 or more can be regarded as a preferable magnetic film.

When S* of a magnetic recording medium is low, it is considered that coercive force varies considerably in respective magnetic domains in the magnetic film, each magnetic domain being a unit of magnetization. Variance in coercive force may be caused by disturbance of crystal orientation of a Co alloy constituting the magnetic film.

When variance in coercive force occurs, coercive force of some magnetic domains is small even if the mean coercive force of the entire magnetic film is large. Such magnetic domains tend to be affected by a demagnetizing field during writing of data, with the result that the recorded data are demagnetized. Residual magnetization, which is an important characteristic, becomes small. As a result, output during data reading is lowered.

Therefore, it can be presumed that a magnetic recording medium having a low S* is strongly affected by a demagnetizing field when recording density is increased.

In Table 2, the symbol “LF” refers to the reproduction signal output when data are recorded at a low frequency (20 MHz). The symbol “OW” refers to the residual amount of low-frequency signal when data recorded at a high frequency (160 MHz) are overlapped on data recorded at a low frequency (20 MHz). The symbol “PW50” refers to isolated read pulse half-width. The symbol “SNR” refers to the ratio of reproduction signal to output noise.

In Table 2, the term “amount of Cr (at %) when the amount of B is 1 at %” refers to the amount of Cr in the vicinity of the interface between the non-magnetic undercoat film 2 and the magnetic film 3 when the amount of B is 1 at %.

TABLE 1

| | | | | | Magnetic film | | | |
|---|---|---|---|---|---|---|---|---|
| | Undercoat film | | | | (Early stage of film | | | |
| | (First) | | (Second) | | growth) | | | |
| | | Thickness | | Thickness | | Thickness | | Thickness |
| | Composition | (Å) | Composition | (Å) | Composition | (Å) | Composition | (Å) |
| Ex. 1 | Cr | 200 | Cr10Mo | 50 | Co40Cr | 20 | Co22Cr10Pt5B | 180 |
| Ex. 2 | Cr | 200 | Cr20W | 50 | Co40Cr | 20 | Co22Cr10Pt5B | 180 |
| Ex. 3 | Cr | 200 | Cr25V | 50 | Co40Cr | 20 | Co22Cr10Pt5B | 180 |
| Ex. 4 | Cr | 200 | — | — | Co40Cr | 20 | Co22Cr10Pt5B | 180 |
| Ex. 5 | Cr | 200 | Cr10Mo | 50 | Ni40Cr | 20 | Co22Cr10Pt5B | 180 |
| Ex. 6 | Cr | 200 | Cr20W | 50 | Ni40Cr | 20 | Co22Cr10Pt5B | 180 |
| Ex. 7 | Cr | 200 | Cr25V | 50 | Ni40Cr | 20 | Co22Cr10Pt5B | 180 |
| Ex. 8 | Cr | 200 | — | — | Ni40Cr | 20 | Co22Cr10Pt5B | 180 |
| Comp. | Cr | 200 | Cr10Mo | 50 | — | — | Co22Cr10Pt5B | 180 |
| Ex. 1 | | | | | | | | |
| Comp. | Cr | 200 | Cr20W | 50 | — | — | Co22Cr10Pt5B | 180 |
| Ex. 2 | | | | | | | | |
| Comp. | Cr | 200 | Cr25V | 50 | — | — | Co22Cr10Pt5B | 180 |
| Ex. 3 | | | | | | | | |
| Comp | Cr | 200 | — | — | — | — | Co22Cr10Pt5B | 180 |
| Ex. 4 | | | | | | | | |

TABLE 2

| | | | | | | | Amount of |
|---|---|---|---|---|---|---|---|
| | | | | | | | Cr (at %) |
| | Hc | S* | LF | OW | PW50 | SNR | when B is |
| | (Oe) | (−) | (μV) | (dB) | (Å) | (dB) | 1 at % |
| Ex. 1 | 3850 | 0.85 | 1425 | 30 | 10.1 | 25.3 | 38 |
| Ex. 2 | 3840 | 0.84 | 1390 | 31 | 10.5 | 24.9 | 36 |
| Ex. 3 | 4160 | 0.88 | 1480 | 30 | 9.5 | 26.1 | 40 |
| Ex. 4 | 3500 | 0.82 | 1380 | 31 | 10.9 | 25.1 | 38 |
| Ex. 5 | 3840 | 0.83 | 1423 | 32 | 10.2 | 25.1 | 35 |
| Ex. 6 | 3780 | 0.82 | 1395 | 35 | 10.3 | 24.7 | 34 |
| Ex. 7 | 4110 | 0.86 | 1482 | 33 | 9.4 | 25.9 | 40 |
| Ex. 8 | 3520 | 0.84 | 1370 | 35 | 10.8 | 25 | 38 |
| Comp. | 3100 | 0.65 | 1205 | 32 | 12.5 | 23.5 | 89 |
| Ex. 1 | | | | | | | |
| Comp. | 2960 | 0.67 | 1125 | 33 | 13.5 | 22.4 | 75 |
| Ex. 2 | | | | | | | |
| Comp. | 3320 | 0.75 | 1307 | 33 | 11.5 | 24 | 65 |
| Ex.3 | | | | | | | |
| Comp. | 2740 | 0.6 | 1080 | 35 | 13.6 | 21.2 | 80 |
| Ex. 4 | | | | | | | |

As apparent from Tables 1 and 2, the magnetic recording media of the Examples produced from a first target consisting of Co40Cr or Ni40Cr, not containing B, at an early stage of film formation, and then a second target consisting of Co22Cr10Pt5B so that the amount of Cr was 40 at % or less when the amount of B was 1 at %, exhibited excellent magnetic characteristics, such as coercive force, compared with the magnetic recording media of Comparative Examples, in which only the second target was employed during formation of the magnetic film 3, and the amount of Cr was in excess of 40 at % when the amount of B was 1 at %.

As described hereinabove, in the vicinity of the interface between the non-magnetic undercoat film and the magnetic film of the magnetic recording medium of the present invention, the amount of Cr is 40 at % or less in the region, in which the amount of B is 1 at % or more. Therefore, coexistence of large amounts of Cr and B in the vicinity of the above region is prevented; formation of a covalent compound from Cr and B is largely suppressed; and disturbance of the orientation of the magnetic film, which is caused by the covalent compound, can be prevented. As a result, magnetic characteristics of the magnetic recording medium, such as coercive force, can be enhanced.

According to the process for producing the magnetic recording medium of the present invention, a magnetic recording medium, which prevents disturbance of orientation in the magnetic film and in which coercive force is enhanced, can be produced.

According to the magnetic recording and reproducing apparatus of the present invention, coercive force of the magnetic recording medium is enhanced, and recording density is increased.

While the invention has been described in detail and with reference to specific embodiments thereof, it will be apparent to one skilled in the art that various changes and modifications can be made therein without departing from the spirit and scope thereof.

What is claimed is:

1. A magnetic recording medium comprising a substrate; a non-magnetic undercoat film containing Cr; and a magnetic film comprising a B-containing Co alloy in order, wherein an amount of Cr is 40 at % or less in a region where an amount of B is 1 at % or more in a vicinity of an interface between the non-magnetic undercoat film and the magnetic film.

2. A magnetic recording medium according to claim 1, wherein the Co alloy contains Pt in an amount of 1-20 at % and B in an amount of 1-10 at %.

3. A magnetic recording medium according to claim 1 or 2, wherein the magnetic film has large amounts of magnetic crystal grains with a mean size of 6-20 nm, and the grains are separated from one another by intergrain regions.

4. A magnetic recording medium according to claim 1 or 2, wherein the non-magnetic undercoat film comprises Cr or a Cr alloy, wherein the Cr alloy contains one or more alloys selected from the group consisting of CrMo, CrW, CrV, and CrTi.

5. A magnetic recording medium according to claim 1 or 2, wherein the non-magnetic substrate has a mean surface roughness (Ra) of 0.1-1 nm.

6. A process for producing a magnetic recording medium, which comprises providing a non-magnetic undercoat film containing Cr on a substrate; and providing a magnetic film formed from a B-containing Co alloy on the undercoat film, wherein the magnetic film is formed so that an amount of Cr is 40 at % or less in a region where an amount of B is 1 at % or more in a vicinity of an interface between the non-magnetic undercoat film and the magnetic film.

7. A magnetic recording and reproducing apparatus comprising a magnetic recording medium and a magnetic head for recording data into the medium and reproducing the data therefrom, wherein the magnetic recording medium comprises a substrate, a non-magnetic undercoat film containing Cr, and a magnetic film comprising a B-containing Co alloy in order; and wherein an amount of Cr is 40 at % or less in a region where an amount of B is 1 at % or more in a vicinity of an interface between the non-magnetic undercoat film and the magnetic film.
